(19) United States
(12) Patent Application Publication
(10) Pub. No.: US 2014/0376778 A1
(43) Pub. Date: Dec. 25, 2014

(54) LICENSE PLATE RECOGNITION SYSTEM AND LOCATION FORECASTING

(71) Applicant: ZF Friedrichshafen AG, Friedrichshafen (DE)

(72) Inventors: Ronald Muetzel, Hawthorn Woods, IL (US); Thomas Roesch, Friedrichshafen (DE)

(21) Appl. No.: 13/926,349

(22) Filed: Jun. 25, 2013

(51) Int. Cl. G06K 9/32

(52) U.S. Cl. CPC G06K 9/325
USPC 382/105

(57) ABSTRACT

A license plate recognition system may include a vehicle and an analysis server. The vehicle may include an image capture device and an on-board device. The image capture device may capture a vehicle image that includes a license plate of a target vehicle. The on-board device may capture various vehicle data of the target vehicle, such as speed, direction, and location. The analysis server may receive and process the vehicle image and/or vehicle data to determine whether alert criteria are met, e.g., if the target vehicle is stolen. If so, the analysis server may send an alert indication to the vehicle that may include a possible current location of the target vehicle.

### BACKGROUND OF THE INVENTION

1. Field of the Invention

The invention relates to a license plate recognition system. The invention also relates to forecasting a location of a vehicle.

2. Related Art

Vehicle traffic today is immense. Along a particular street or route, a vehicle may encounter dozens or hundreds of other vehicles, each with unique license plate information. A police vehicle, for example, may patrol a street and encounter dozens of vehicles, each with a different license plate. The police vehicle may lack knowledge as to whether any of the encountered vehicles are, for example, stolen or subject to a search warrant. A police officer may manually communicate a license plate string to headquarters by radio if she is able to memorize the string while a particular vehicle is in view. The officer, however, may be unable to manually communicate by radio each of the dozens of vehicles passing through a busy street or intersection at any given time. Moreover, if the officer later receives notice that a particular vehicle is, for example, stolen, she may be unable to identify a current location of the stolen vehicle even after having observed the vehicle's license plate string. Thus, there is a need for a system that recognizes license plates and forecasts a location of vehicles with recognized license plates.

### SUMMARY OF THE INVENTION

The descriptions below include systems and methods for license plate recognition and location forecasting.

A vehicle may comprise an image capture device operable to capture a vehicle image that includes a license plate of a target vehicle. The vehicle may also comprise an on-board device, for example, integrated in the vehicle. The on-board device may be operable to capture target vehicle data that may include a speed of the target vehicle. The on-board device may transmit the vehicle image and the target vehicle data to an external processing system, and receive an alert indication from the external processing system when the license plate of the target vehicle meets a predetermined alert criterion.

A license plate recognition system may comprise recognition logic operable to receive a target vehicle image that includes a license plate of a target vehicle, extract a license plate string from the target vehicle image, and determine whether the extracted license plate string satisfies one or more predetermined alert criterion. When the extracted license plate satisfies the predetermined alert criterion, the recognition logic may send an alert indication to a destination vehicle.

A method of license plate recognition may comprise, in a first vehicle, capturing a target vehicle image that includes a license plate of a target vehicle; capturing target vehicle data comprising a speed and a travel direction of the target vehicle; sending the target vehicle image and the target vehicle data to an external processing system; and receiving an alert indication from the external processing system when the license plate of the target vehicle meets a predetermined alert criteria.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The embodiments described below may be more fully understood by reading the following description in conjunction with the drawings, in which

FIG. 1 is a diagram of a license plate recognition and location forecasting system;

FIG. 2 is a diagram of a license plate recognition and location forecasting system;

FIG. 3 is a diagram of a license plate recognition and location forecasting system;

FIG. 4 is a flow diagram of a method for license plate recognition; and

FIG. 5 is a flow diagram of a method for analyzing a vehicle image and vehicle data.

### DETAILED DESCRIPTION

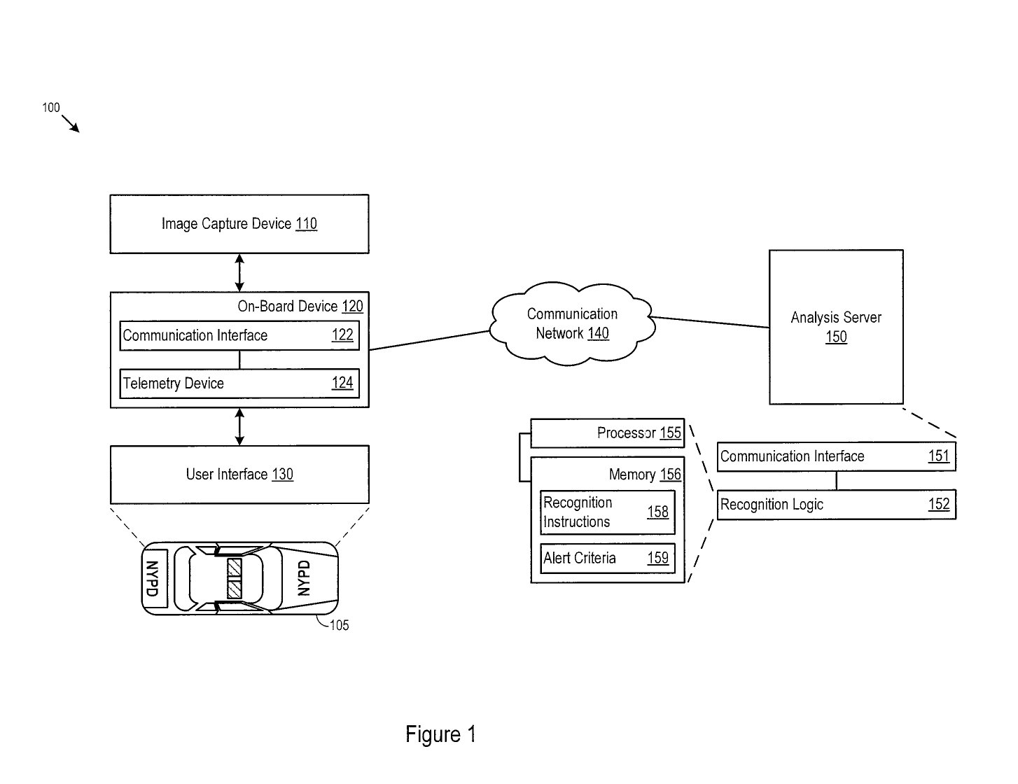

FIG. 1 illustrates a diagram of a license plate recognition and location forecasting system 100 according to one embodiment of the invention. The license plate recognition and location forecasting system 100 includes vehicle 105. The exemplary vehicle shown in FIG. 1 is a police car. However, vehicle 105 may take any number of forms, including as examples, a car, bus, truck, van, mini-van, sports utility vehicle (SUV), construction vehicle, motorcycle, trailer, all-terrain vehicle (ATV), moped, tractor, hybrid vehicle, electric vehicle, ambulance, fire truck, helicopter, airplane, marine vessel, boat, submarine, or other vehicle.

Vehicle 105 may include an image capture device 110, on-board device 120, and user interface 130, any combination of which may be integrated, e.g., installed, within vehicle 105. Image capture device 110 may be any device operable to capture a digital image, such as a camera of any form or type. As discussed in greater detail below, the image capture device 110 may capture digital images that include the license plate of a target vehicle.

On-board device 120 may be communicatively linked to image capture device 110 and user interface 130. In one implementation, on-board device 120 may include a communication interface 122 communicatively linked with telemetry device 124. On-board device 120 may communicate with any number of communication networks through communication interface 122, including communication network 140, which may take any number of forms such as a wireless network. On-board device 120 may communicate according to any number of communication protocols, standards, networks, or topologies. As examples, on-board device 120 may communicate across cellular networks or standards (e.g., 2G, 3G, Universal Mobile Telecommunications System (UMTS), GSM® Association, Long Term Evolution (LTE)™, or more), WiMAX, Bluetooth, WiFi (including 802.11 a/b/g/n/ac or others), WiGig, Global Positioning System (GPS) networks, and others available at the time of the filing of this application or that may be developed in the future. On-board device 120 may include processing circuitry, data ports, transmitters, receivers, transceivers, or any combination thereof to communicate across any of the above-listed protocols, standards, networks, or topologies.

On-board device 120 may be configured according to any number of user requirements with respect to communication capabilities, data transfer configurations, data collection configurations, and other configurations. On-board device 120 may also collect any type of vehicle data, such as performance statistics, route information, position data, traffic data, and others. In that regard, on-board device 120 may collect vehicle data with respect to the vehicle 105, different vehicles, groups of vehicles, or any combination thereof. In one example, on-board device 120 may include telemetry functionality or logic, such as the telemetry device 124, to collect and/or send vehicle data. Telemetry device 124 may function to capture measurements or records of speed, direction, acceleration, pitch, yaw, and roll, and measurements or records of rate of change for speed, direction, acceleration, pitch, yaw, and roll. One example of on-board device 120 is the Openmatics© on-board unit provided by ZF Friedrichshafen AG.

On-board device 120 may communicate with analysis server 150 through one or more communication networks, such as communication network 140 shown in FIG. 1. Analysis server 150 may include communication interface 151 and recognition logic 152, which in one example is implemented as processor 155 and memory 156 storing recognition instructions 158 and alert criteria 159.

In operation, and as described in greater detail below, image capture device 110 may capture a vehicle image of a target vehicle. The captured vehicle image may include a license plate of the target vehicle. Telemetry device 124 may capture vehicle data with respect to the target vehicle, including any of the measurements or records enumerated above, such as a speed and travel direction of the target vehicle. On-board device 120 may then send the captured vehicle image and vehicle data to analysis server 150.

Upon receiving the vehicle image, analysis server 150 may analyze the vehicle image to extract a license plate string. The license plate string may be, for example, an alphanumeric string corresponding to the vehicle license plate in the vehicle image. Analysis server 150 may utilize any known image processing methods to extract the license plate string from the vehicle image, including processes that include sharpening, contrast manipulation, noise reduction, orienting, filtering, magnification, interpolation, de-skewing, Optical Character Recognition (OCR), and others. The analysis server 150 may be unable to extract the license plate string in certain circumstances, e.g., upon determining that the capture image does not contain a license plate or upon determining that the quality of the captured vehicle image is below an extraction threshold. In this case, the analysis server 150 may send an extraction error indication to the vehicle 105. Analysis server 150 may also partially extract a license plate string from the captured vehicle image.

In one example, analysis server 150 may particularly identify a license plate string from a vehicle image while ignoring or discarding other text, images, or indicia from the captured vehicle image. In that regard, analysis server 150 may identify a license plate string according to license plate requirements or characteristics of a particular location, state, country, or jurisdiction, e.g., a particular string length or range, restricted characters, etc. Analysis server 150 may also extract additional vehicle identifying information from the license plate in the captured vehicle image, such as a state or jurisdiction issuing the license plate, expiration date, e.g., from an expiration sticker, or other information. In one implementation, analysis server 150 disregards other text or indicia in the vehicle image, such as bumper stickers, decals, other decorative patterns or images.

Analysis server 150 may perform additional analysis based on the extracted license plate string, partially extracted license plate string, additional vehicle identifying information, or any combination thereof. Analysis server 150 may access a database including vehicle information, registrant information, or other information. The database may store entries according to vehicle license plates. For example, the accessed database may identify stolen vehicles by license plate, arrest warrants for a registrant associated with a license plate, manufacturer-recalled vehicles by license plate, or more. Analysis server 150 may maintain a local database and/or access external databases storing vehicle information.

Analysis server 150 may send an alert indication when the license plate string satisfies predetermined alert criteria 159. The alert criteria 159 may be satisfied when one or more accessed databases contain an entry associated with the extracted license plate string, e.g., when the extracted license plate string matches a stolen vehicle plate number. Analysis server 150 may also determine one or more possible current locations of the target vehicle from which the extracted license plate string came from. Analysis server 150 may determine the possible current location of the target vehicle using any number of data, including as examples received vehicle data captured by the on-board device 120, location data of the target vehicle or vehicle 105, geographical data of the area surrounding the location data, street layout of the surrounding area, elapsed time from receiving the location data of the target vehicle, or more.

Analysis server 150 may send the alert indication to the on-board device 120, which may include the determined possible current location(s) of the target vehicle. On-board device 120 may present the alert indication to occupants of vehicle 105 through the user interface 130 audibly, visually, or both.

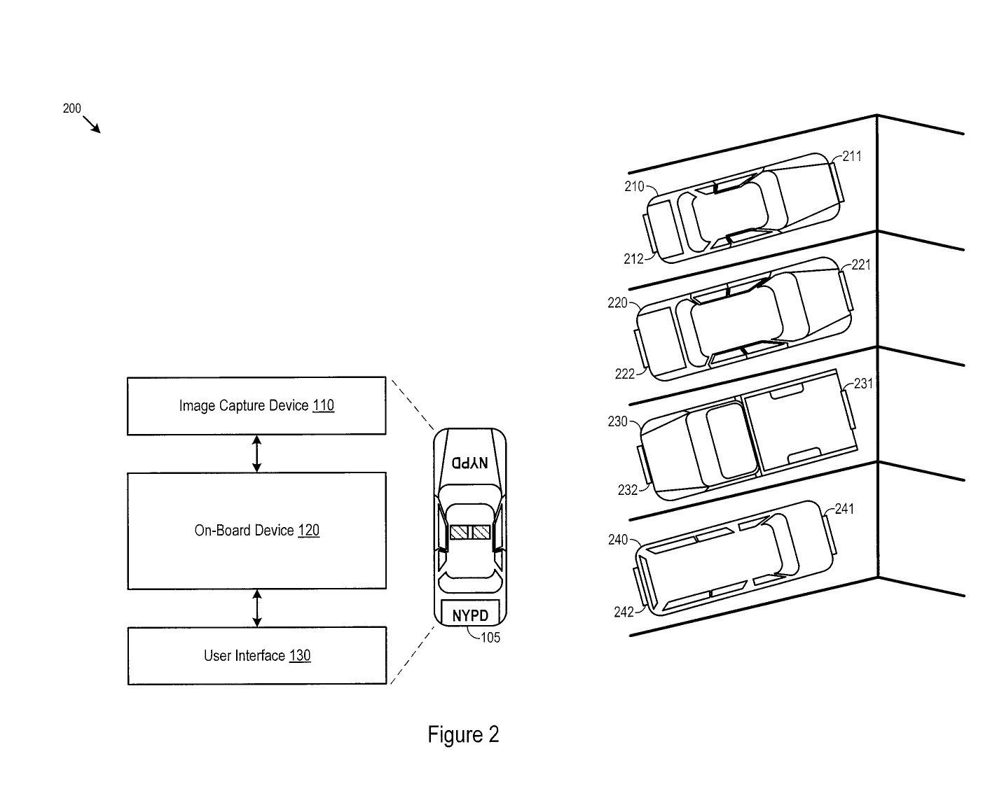

FIG. 2 shows a diagram of a license plate recognition and location forecasting system 200 according to another embodiment of the invention. The license plate recognition and location forecasting system 200 includes vehicle 105 with image capture device 110, on-board device 120, and user interface 130. Image capture device 110 may be located at any position in vehicle 105 and oriented in any direction, e.g., forward facing, rear facing, side facing, or others.

Vehicle 105 may capture, e.g., through image capture device 110, vehicle images and/or vehicle data of stationary vehicles, moving vehicles, or both. Moreover, vehicle 105 may capture vehicle images while vehicle 105 itself is moving or stationary. The example shown in FIG. 2 depicts vehicle 105 moving and capturing vehicle images of stationary vehicles labeled as car 210, car 220, truck 230, and mini-van 240, each parked in a parking lot. Car 210 includes front license plate 211 and rear license plate 212. Similarly, car 220, truck 230, and mini-van 240 respectively include front license plates 221, 231, and 241 as well as rear license plates 222, 232, and 242.

Image capture device 110 may be automatically or manually oriented to capture vehicle images for one or more target vehicles. In one implementation, on-board device 120 may automatically initiate capture of a vehicle image when the license plate of a target vehicle is within view of image capture device 110. For example, when rear license plate 242 of mini-van 240 is within the view of image capture device 110, on-board device 120 may automatically instruct image capture device 110 to capture a vehicle image of mini-van 240 that includes rear license plate 242. As an alternative, an occupant of vehicle 105, e.g., a passenger, may manually orient or position image capture device 110 and/or initiate the capture of a vehicle image. In this example, the view of image capture device 110 may be presented to the occupant prior to capture of the vehicle image, e.g., as a preview function displayed through user interface 130, which may allow the occupant to identify when a license plate of a vehicle such as rear license plate 242 is within view for capture.

On-board device 120 may capture vehicle data for target vehicles, including stationary vehicles 210, 220, 230, and 240. On-board device 120 may identify when a target vehicle is stationary based on the captured vehicle data of the target vehicle, e.g., when the captured speed of a target vehicle is zero. On-board device 120 may receive a captured vehicle image of a target vehicle from image capture device 110 and send the captured vehicle image and captured vehicle data of the target vehicle to analysis server 150. In an exemplary implementation, on-board device 120 may send a communication to analysis server 150 that includes the captured vehicle image, the target vehicle location, target vehicle speed, target vehicle direction, and capture time of the vehicle image and/or vehicle data.

On-board device 120 may receive an alert indication from analysis server 150. The alert indication may identify a target vehicle. As one illustration, on-board device 120 may receive an alert indication identifying car 220 as a stolen vehicle. The alert indication may also communicate that the license plate string extracted from an image of rear license plate 222 belongs to a stolen vehicle. The alert indication may provide any other identifying information with respect to the target vehicle as well, including a possible location of car 220. For a stationary target vehicle, the possible location included in an alert indication may be identical to the vehicle position captured by the on-board device 120 earlier. User interface 130 may then present the received alert indication, e.g., to an occupant of vehicle 105 either visually, audibly, or both.

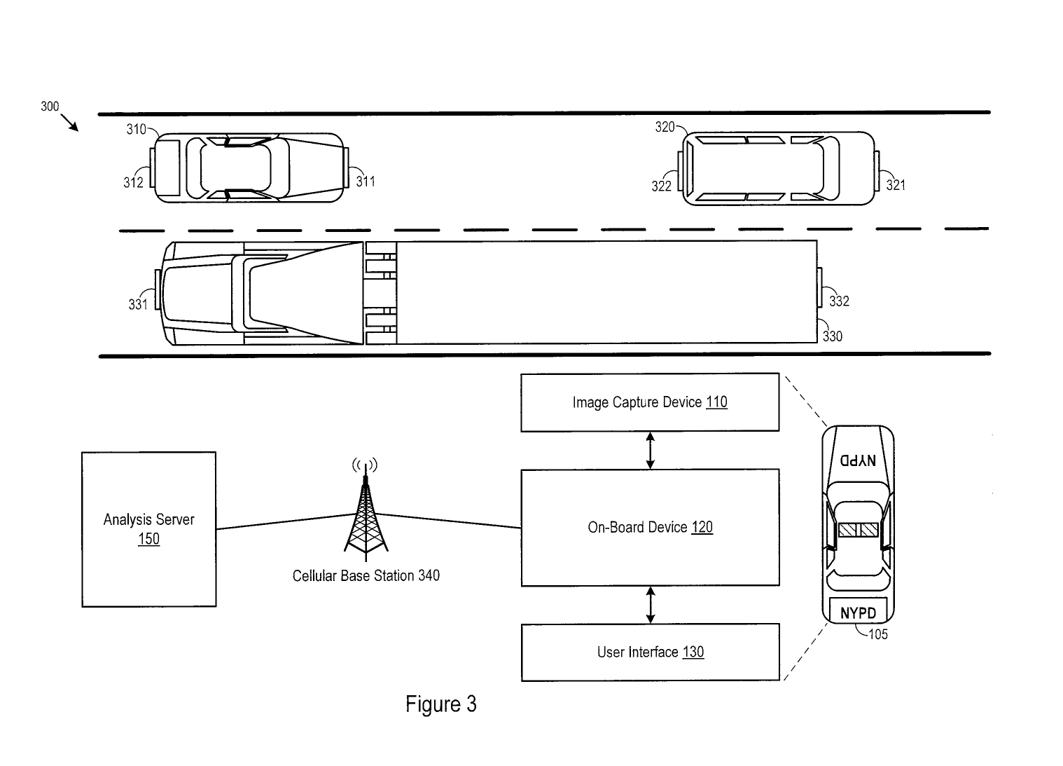

FIG. 3 is a diagram of a license plate recognition and location forecasting system 300 according to another embodiment of the invention. In FIG. 3, vehicle 105 is stationary and captures vehicle images and/or vehicle data of moving target vehicles, such as car 310, mini-van 320, or semi-truck 330. Vehicle 105 may use image capture device 110 to capture a vehicle image that includes a license plate of a target vehicle, which may be the front license plate of a target vehicle, such as respective front license plates 311, 321, and 331 of target vehicles 310, 320, and 330, or a rear license plate, such as rear license plates 312, 322, and 332. On-board device 120 may also capture any number of vehicle data with respect to a moving target vehicle, e.g., mini-van 320.

An illustrative example is provided next with respect to FIG. 3. On-board device 120 determines that the front license plate 321 of mini-van 320 is within the view of image capture device 110. In response, on-board device 120 instructs image capture device 110 to capture a vehicle image of mini-van 320 that includes front license plate 321. In this regard, on-board device 120 may automatically initiate the capture of a vehicle image without user intervention. At or around the same time, on-board device 120 also captures vehicle data with respect to mini-van 320, which may include the speed of mini-van 320, the location of mini-van 320, the travel direction of mini-van 320, or other vehicle data.

On-board device 120 sends the captured vehicle image and vehicle data of mini-van 320 to analysis server 150. In this illustration, on-board device 120 communicates with analysis server 150 through a cellular communication link that includes cellular base station 340 and any number of other communication devices, networks, or structures.

Analysis server 150 receives and processes the captured vehicle image of mini-van 320. As discussed above, analysis server 150 extracts a license plate string from the vehicle image depicting front license plate 321. Analysis server 150 then determines whether the extracted license plate string satisfies predetermined alert criteria. In doing so, analysis server 150 may access a local or external database to search for entries identifying the extracted license plate string. The predetermined alert criteria may relate to a target vehicle, e.g., mini-van 320, or entities associated with the target vehicle, e.g., a registered owner of the mini-van 320. Based on the extracted license plate string, analysis server 150 may determine if the mini-van 320 is, for example, a stolen vehicle, subject to a search warrant, subject to emergency recall, registered to a person or company subject to a search warrant or police investigation, or more. When the extracted license plate string satisfies the predetermined criteria, analysis server 150 prepares an alert indication to send to on-board device 120 of vehicle 105.

To generate an alert indication, analysis server 150 processes the received captured vehicle data of the mini-van 320. In one implementation, analysis server 150 processes captured vehicle data when an extracted license plate string of the target vehicle satisfies one or more predetermined alert criteria. Analysis server 150 may determine one or more possible current locations of mini-van 320. In that regard, analysis server 150 may utilize the captured speed, location, and/or direction of mini-van 320 to determine the possible current location of mini-van 320. Analysis server 150 may also identify the amount of time that has elapsed since on-board device 120 captured the vehicle data of mini-van 320. Analysis server 150 may use the elapsed time since capturing of vehicle data to determine a possible distance range that mini-van 320 has since traveled or to narrow the possible current locations of mini-van 320. Additionally or alternatively, analysis server 150 may access and utilize additional location determination data to determine a possible current location of mini-van 320, including as examples traffic congestion data, geographical data, street layout data, traffic signal data, street direction data, or more. In one implementation, analysis server 150 may determine possible routes mini-van 320 could have taken based on any combination of the data above, and identify one or more possible current locations of the mini-van 320. Analysis server 150 may send the possible current location(s) of the target vehicle, e.g., mini-van 320, to on-board device 120 of vehicle 105 as part of an alert indication. Additionally or alternatively, analysis server 150 may send the alert indication to another vehicle, for example another police car at a closer proximity to a possible current location of the target vehicle than vehicle 105.

Upon receiving the alert indication, vehicle 105 may present the alert indication through user interface 130. User interface 130 may present identifying characteristics of mini-van 320 from the alert indication, such as the make, model, color, extracted license plate string, registrant, owner, etc. User interface 130 may present information regarding the satisfied predetermined criteria, for example, indicating that mini-van 320 was stolen or that the owner of mini-van 320 is subject to an arrest warrant. User interface 130 may also present possible current locations of the mini-van 320, e.g., through a map and indicators on the map corresponding to the possible current locations. In this way, vehicle 105 and analysis server 150 may capture and analyze the license plate of a target vehicle and forecast a possible current location of the target vehicle.

In one implementation, analysis server 150 may process the received vehicle image and vehicle data of a target vehicle in real-time, providing a near immediate response after vehicle 105 sends the captured vehicle image and data. Real-time processing by analysis server 150 may incorporate delays caused by the processing capability, latency, or current load of analysis server 150.

Any portion or logic associated with analysis server 150, such as the recognition logic 152, may be implemented in vehicle 105, e.g., as part of on-board device 120. This design may provide increased speed in processing captured vehicle images and vehicle data and lower the latency in receiving alert indications.

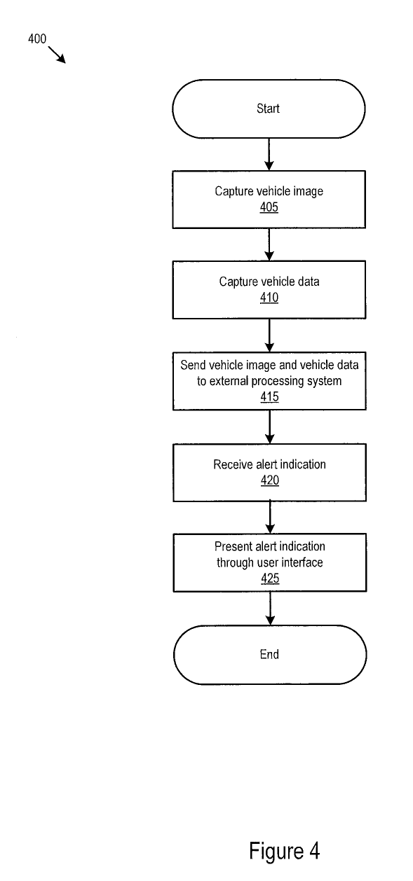

FIG. 4 is a flow diagram of a method 400 for license plate recognition according to one embodiment of the invention. Method 400 may be implemented as hardware, software, or both. For example, vehicle 105 may implement method 400, e.g., through any combination of image capture device 110, on-board device 120, and user interface 130.

Method 400 may start and continue to step 405, where image capture device 110 may capture a vehicle image including the license plate of a target vehicle. At step 410, which may occur at substantially the same time as step 405, on-board device 120 may capture vehicle data of the target vehicle, including as examples, the target vehicle's location, speed, and direction. On-board device 120 may also track a capture time indicative of when the target vehicle data was captured.

At step 415, on-board device 120 may send the vehicle image and vehicle data to an external processing system, such as analysis server 150. On-board device 120 may utilize any communication means to communicate the captured vehicle image and vehicle data. For example, on-board device 120 may wirelessly transmit the vehicle image and vehicle data through a cellular connection, or through any of the other methods discussed above.

At step 420, on-board device 120 may receive an alert indication from the external processing system. The alert indication may take the form of any of the alert indications discussed above and may include, with respect to the target vehicle, a license plate string, a particular alert criterion the license plate string satisfied, a possible current location, or other information. At step 425, user interface 130 may present the received alert indication.

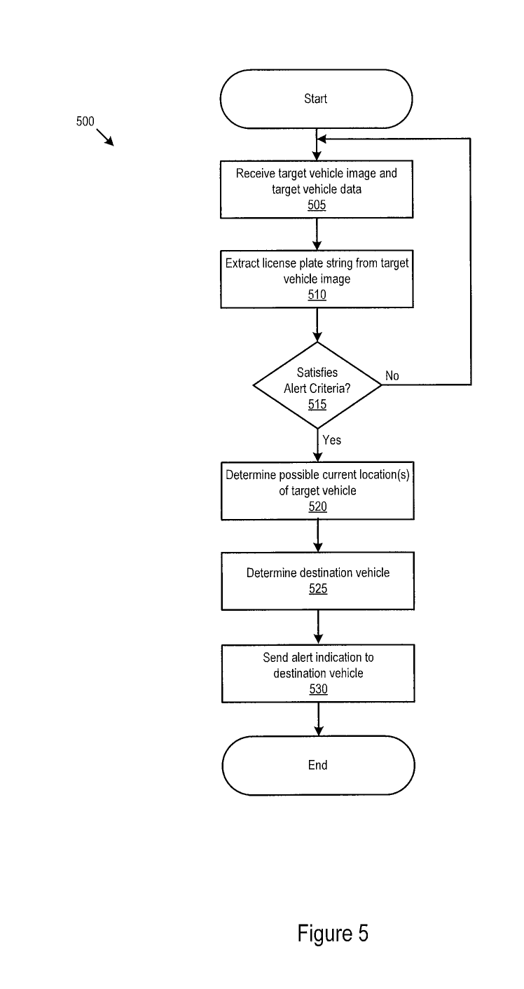

FIG. 5 is a flow diagram of a method 500 for analyzing a vehicle image and vehicle data according to one embodiment of the invention. Method 500 may be implemented as hardware, software, or both. Analysis server 150 may implement any portion of method 500, for example in software as the recognition instructions 158.

Method 500 may start and continue to step 505, where analysis server 150 may receive a target vehicle image and target vehicle data. At step 510, analysis server 150 extracts a license plate string from the target vehicle image according to any number of image processing techniques.

At step 515, analysis server 150 determines whether the extracted license plate string satisfies alert criteria 159. The alert criteria 159 may be configured in any number of ways, e.g., with respect to the extracted licensed string, to a person or entity associated with the extracted license plate string, to a vehicle associated with the extracted license plate string, or more. The alert criteria 159 may be configured according to any of the examples described above, and may be satisfied when, for example, the extracted license plate string corresponds to a stolen vehicle. Analysis server 150 may access any number of information sources to analyze the extracted license string in determining whether the extracted license string satisfies the alert criteria 159, e.g., stolen vehicle databases maintained by local, state, or federal law enforcement agencies.

When the extracted license plate string does not satisfy the alert criteria 159, the method 500 may return to the start and continue again at step 505. When the extracted license plate string satisfies the alert criteria 159, at step 520, analysis server 150 determines a possible current location of the target vehicle. Analysis server 150 may analyze data from any number of sources to forecast a current location of the target vehicle, including any of the captured vehicle data or additional location determination data described above.

At step 525, analysis server 150 may determine one or more destination vehicles to send an alert indication to. For example, analysis server 150 may determine to send the alert indication to the vehicle that sent the vehicle image and vehicle data. Additionally or alternatively, analysis server 150 may determine a destination vehicle based a possible current location of the target vehicle. Analysis server 150 may select, from a set of potential vehicles, for example, available police cars, a destination vehicle that is geographically closest to a current possible location of the target vehicle. Analysis server 150 may incorporate other factors in determining a destination vehicle, such as estimated travel time to the target vehicle, direction of the target vehicle, traffic congestion levels, street directions and layouts, and other data.

Analysis server 150 may determine a destination vehicle based on the satisfied alert criteria. A particular destination vehicle or type of destination vehicle may be associated with particular alert criteria. For example, when an extracted license plate string corresponds to a stolen vehicle, analysis server may select from available on-duty police vehicles to select a destination vehicle. As another example, when an extracted license plate string corresponds to a vehicle subject to manufacturer's recall, analysis server 150 may identify a service vehicle as a destination vehicle. At step 530, analysis server 150 may send the alert indication to the determined destination vehicle(s).

Although discussed above with respect to analysis server 150, vehicle 105 may implement any portion of the method 500 as well, e.g., through any combination of image capture device 110, on-board device 120, and user interface 130. Analysis server 150 and vehicle 105 may implement method 500 in combination to process a target vehicle image and target vehicle data.

Methods or processes may be implemented, for example, using a processor and/or instructions or programs stored in a memory. Specific components of the disclosed embodiments may include additional or different components. A processor may be implemented as a microprocessor, microcontroller, application specific integrated circuit (ASIC), discrete logic, or a combination of other types of circuits or logic. Similarly, memories may be DRAM, SRAM, Flash, or any other type of memory. Parameters, databases, and other data structures may be separately stored and managed, may be incorporated into a single memory or database, or may be logically and physically organized in many different ways. Programs or instruction sets may be parts of a single program, separate programs, or distributed across several memories and processors.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

I claim:

1. A vehicle comprising:
an image capture device integrated in the vehicle operable to capture a target vehicle image that includes a license plate of a target vehicle; and
an on-board device integrated in the vehicle operable to:
capture target vehicle data comprising a speed of the target vehicle;
send the target vehicle image and the target vehicle data to an external processing system; and
receive an alert indication from the external processing system when the license plate of the target vehicle meets a predetermined alert criteria.

2. The vehicle of claim 1, where the target vehicle data further comprises a location of the target vehicle.

3. The vehicle of claim 1, where the target vehicle data further comprises a travel direction of the target vehicle.

4. The vehicle of claim 1, where the alert indication indicates a possible current location of the target vehicle.

5. The vehicle of claim 1, where the alert indication indicates multiple possible current locations of the target vehicle.

6. The vehicle of claim 1, where the alert indication comprises a license plate string of the target vehicle.

7. The vehicle of claim 1, further comprising a user interface operable to present the alert indication.

8. The vehicle of claim 7, where the user interface is operable to display a map and mark a possible current location of the target vehicle on the map.

9. The vehicle of claim 1, where the on-board device is operable to send the target vehicle image, the target vehicle data, or both to the external processing system through a wireless communication.

10. The vehicle of claim 1, where the predetermined alert criteria is met when the license plate of the target vehicle matches a stolen vehicle plate number.

11. A license plate recognition system comprising:
recognition logic operable to:
receive a target vehicle image that includes a license plate of a target vehicle;
extract a license plate string from the target vehicle image; and
determine whether the extracted license plate string satisfies a predetermined alert criteria; and when the extracted license plate satisfies the predetermined alert criteria:
send an alert indication to a destination vehicle.

12. The license plate recognition system of claim 11, where the recognition logic is operable to determine the predetermined alert criteria is satisfied when the extracted license plate string matches a stolen vehicle plate number.

13. The license plate recognition system of claim 11, where the recognition logic is further operable to:
receive vehicle data with respect to the target vehicle;
determine a possible current location of the target vehicle based on the received vehicle data; and
send the possible current location to the destination vehicle as part of the alert indication.

14. The license plate recognition system of claim 13, where vehicle data comprises a speed of the target vehicle.

15. The license plate recognition system of claim 13, where vehicle data comprises a travel direction of the target vehicle.

16. The license plate recognition system of claim 13, where recognition logic is operable to determine the possible current location of the target vehicle further based on a possible travel route of the target vehicle.

17. The license plate recognition system of claim 13, where recognition logic is operable to determine the possible current location of the target vehicle further based on an elapsed time since the recognition logic received the vehicle data.

18. The license plate recognition system of claim 13, where the recognition logic is further operable to select the destination vehicle based on the determined possible current location of the target vehicle.

19. A method of license plate recognition, the method comprising:
capturing a target vehicle image that includes a license plate of a target vehicle;
capturing target vehicle data comprising a speed and travel direction of the target vehicle;
sending the target vehicle image and the target vehicle data to an external processing system; and
receiving an alert indication from the external processing system when the license plate of the target vehicle meets a predetermined alert criteria.

20. The method of license plate recognition of claim 19, where receiving the alert indication comprises receiving a possible current location of the target vehicle.
